(19) United States
(12) Patent Application Publication
(10) Pub. No.: US 2023/0409277 A1
(43) Pub. Date: Dec. 21, 2023

(54) ENCRYPTING AND/OR DECRYPTING AUDIO DATA UTILIZING SPEAKER FEATURES

(71) Applicant: GOOGLE LLC, Mountain View, CA (US)

(72) Inventors: Matthew Sharifi, Kilchberg (CH); Victor Carbune, Zurich (CH)

(21) Appl. No.: 17/845,728

(22) Filed: Jun. 21, 2022

(51) Int. Cl. G06F 3/16; H04L 9/08; G10L 15/22; G10L 15/08

(52) U.S. Cl. CPC G06F 3/165; H04L 9/08; G10L 15/22; G10L 15/08

(57) ABSTRACT

Implementations relate to encrypting audio data utilizing utterance features generated from the audio data. Some of those implementations include generating utterance features from a portion of the audio data, encrypting at least part of the audio data using the utterance features, and providing the encrypted audio data to one or more applications for decryption. Speaker features previously generated from utterances are utilized to decrypt the audio data for further processing. Other implementations relate to receiving speaker features and comparing the speaker features to utterance features generated from audio data. The audio data is provided to target applications that provide speaker features that match the utterance features generated from the audio data.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input. An automated assistant responds to a request by providing responsive user interface output, which can include audible and/or visual user interface output.

As mentioned above, many automated assistants are configured to be interacted with via spoken utterances, such as an invocation indication followed by a spoken query. To preserve user privacy and/or to conserve resources, a user must often explicitly invoke an automated assistant before the automated assistant will fully process a spoken utterance. The explicit invocation of an automated assistant typically occurs in response to certain user interface input being received at a client device. The client device includes an assistant interface that provides, to a user of the client device, an interface for interfacing with the automated assistant (e.g., receives spoken and/or typed input from the user, and provides audible and/or graphical responses), and that interfaces with one or more additional components that implement the automated assistant (e.g., remote server device(s) that process user inputs and generate appropriate responses).

Some user commands or requests will only be fully processed and responded to when the automated assistant authenticates the requesting user. For example, to maintain security of personal data, user authentication can be required for requests that access personal data of the user in generating a response and/or that would incorporate personal data of the user in the response. For instance, user authentication can be required to appropriately respond to requests such as “what's on my calendar for tomorrow” (which requires accessing the requesting user's personal calendar data and including personal calendar data in a response) and “message Vivian I'm running late” (which requires accessing the requesting user's personal contact data). As another example, to maintain security of smart devices (e.g., smart thermostats, smart lights, smart locks), user authentication can be required for requests that cause control of one or more of such smart devices.

Various techniques for user authentication for automated assistants have been utilized. For example, in authenticating a user, some automated assistants utilize text-dependent techniques (TD) that is constrained to invocation phrase(s) for the assistant (e.g., “OK Assistant” and/or “Hey Assistant”). With such techniques, an enrollment procedure is performed in which the user is explicitly prompted to provide one or more instances of a spoken utterance of the invocation phrase(s) to which the TD features are constrained. Speaker features (e.g., a speaker embedding) for a user can then be generated through processing of the instances of audio data, where each of the instances captures a respective one of the spoken utterances. For example, the speaker features can be generated by processing each of the instances of audio data using a TD machine learning model to generate a corresponding speaker embedding for each of the utterances. The speaker features can then be generated as a function of the speaker embeddings, and stored (e.g., on device) for use in TD techniques. For example, the speaker features can be a cumulative speaker embedding that is a function of (e.g., an average of) the speaker embeddings. Text-independent (TI) techniques have also been proposed for utilization in addition to or instead of TD techniques. TI features are not constrained to a subset of phrase(s) as is in TD. Like TD, TI can also utilize speaker features for a user and can generate those based on user utterances obtained through an enrollment procedure and/or other spoken interactions, although many more instances of user utterances may be required for generating useful TI speaker features.

After the speaker features are generated, the speaker features can be used in verifying that a spoken utterance was spoken by the user. For example, when another spoken utterance is spoken by the user, audio data that captures the spoken utterance can be processed to generate utterance features, those utterance features compared to the speaker features, and, based on the comparison, a determination made as to whether to authenticate the speaker. As one particular example, the audio data can be processed, using the speaker recognition model, to generate an utterance embedding, and that utterance embedding compared with the previously generated speaker embedding for the user in determining whether to verify the user as the speaker of the spoken utterance. For instance, if a distance metric between the generated utterance embedding and the speaker embedding for the user satisfies a threshold, the user can be verified as the user that spoke the spoken utterance. Such verification can be utilized as a criterion (e.g., the sole criterion) for authenticating the user.

Accordingly, various TD and/or TI approaches have been proposed for use by automated assistants and/or other applications in determining whether and/or how to process audio data, capturing spoken utterances, that is provided to the application for processing.

### SUMMARY

Implementations disclosed herein relate to ensuring security of audio data that captures a spoken utterance of a user. For example, various implementations utilize utterance features and/or speaker features (e.g., generated using TD and/or TI approaches) to ensure that unencrypted versions of the audio data are only accessible to component(s) (e.g., processor(s), operating system, and/or application(s)) to which the user has provided authorization for accessing and/or processing their spoken utterances.

Some implementations disclosed herein relate to generating utterance features from audio data that includes the user uttering one or more terms, and utilizing the utterance features to encrypt the audio data. For example, utterance features can be generated based on processing at least a portion of the audio data that includes at least part of the spoken utterance, and the utterance feature(s) can be used as an encryption key in encrypting the portion of audio data. For instance, TD techniques can be used to process an invocation part of the audio data to generate TD utterance features, and the TD utterance features used to encrypt a portion of audio data that includes additional portion(s) of the spoken utterance that precede and/or follow the invocation part. Some of those implementations include processing a stream of audio data to monitor for occurrence of an invocation phrase. In response to detecting the occurrence of the invocation phrase during the monitoring, a part of audio data (e.g., audio data that includes at least a part of a spoken utterance that precedes, follows, and/or includes the invocation phrase) is encrypted and then the encrypted audio data provided to one or more component(s) for further processing. Only component(s) that have access to speaker features, previously derived from one or more features of prior spoken utterance(s) uttered by the same user that provided the utterance, can decrypt the encrypted audio data in order to process the spoken utterance and/or other feature(s) of the decrypted audio data. In these and other manners, only component(s) that have access to the speaker features of the user are able to decrypt the encrypted audio data and generate an unencrypted version of the audio data, thereby ensuring security of audio data that captures a spoken utterance of a user. As a particular example, if the encrypted audio data is provided to a particular application (e.g., an automated assistant application or other application), the particular application would only be able to decrypt the encrypted audio data if the user had previously provided explicit or implicit authorization for the particular application to process their spoken utterances. For example, the particular application could have access to speaker features, for the user, that can be used as a decryption key and could have such access as a result of the user performing an enrollment procedure with the application, granting the application access to speaker features generate from an enrollment procedure performed by another application and/or an operating system, and/or granting the application access to process utterances when the application is in use.

In some implementations, a digital signal processor (DSP) can process audio data of a limited length (e.g., audio data that includes detected utterances of 10 seconds, a set file length, a variable but limited file length) that is stored in a buffer to which only the DSP has authorization to access. When the DSP detects an occurrence of an utterance in the audio data included in the buffer, it can process the audio data to generate utterance features that are indicative of a speaker that has spoken the utterance. For example, the DSP can generate a vector that is indicative of the voice profile of the user that uttered the phrase included in the audio data. The DSP can generate features based on the portion of the utterance that includes the invocation phrase (e.g., a portion of the audio data that includes the user uttering “Hey Assistant”) to generate a vector indicative of the user speaking the phrase and/or of a portion of the audio data that precedes and/or follows the invocation phrase (“Turn on the kitchen lights” following “Hey Assistant” in the utterance) to generate a utterance feature vector of the speaker uttering the non-invocation phrase portion of the audio data.

In some implementations, only a portion of available audio data can be utilized to generate utterance features for audio data. For example, in some implementations, audio data may include audio captured by multiple microphones. In those instances, only a subset of the audio channels can be utilized by the DSP to generate utterance features that can be utilized to encrypt the entirety of the audio data. Thus, computing resources can be conserved by not requiring the DSP (which can have limited computing power and/or resources) to process all of the audio data that is captured.

In some implementations, the stored vector and/or the invocation features can be utilized to encrypt audio data that precedes and/or follows the invocation phrase. For example, a user can utter the phrase “Hey Assistant, turn on the lights” and the DSP can generate invocation features from the portion of audio data that includes “Hey Assistant.” Subsequently, the generated features can be utilized to encrypt the portion of the audio data that includes the user uttering “turn on the lights,” which then can be provided, by the DSP, to one or more applications without providing the unencrypted audio data.

Once provided with encrypted audio data, the one or more applications can process the encrypted audio data to determine whether, based on stored features of the user (or other users) uttering a phrase, the application can decrypt the audio data. In instances where the application has access to, for example, one or more vectors of the user uttering the invocation phrase, the vector(s) can be utilized as a key to decrypt the audio data. If the application can decrypt the audio data, it can then further process the audio data (e.g., perform automatic speech recognition, natural language processing, speech to text processing) to perform one or more actions. If the application cannot decrypt the audio data because, for example, it does not have access to a vector that successfully decrypts the audio data, the data can remain secure and the application will be unable to determine what is further included in the audio data.

Thus, implementations disclosed herein mitigate the need to determine to which applications to provide a spoken utterance, thereby reducing processing time and power consumption required to be expended by the DSP. Further, implementations described herein improve security measures by reducing access of spoken utterances by applications that the user may have interest in not being provided with the audio data. Thus, implementations described herein reduce computing requirements of components that can have limited computing resources (e.g., a DSP) while maintaining the security of audio data that is received from a user.

In some implementations, features that are determined based on the invocation phrase and/or other portions of the spoken utterance may not be an exact match to a stored vector representing a user speaker speaking an utterance. For example, due to terms uttered in the spoken phrase, differences in prosodic characteristics of the user uttering the invocation phrase (e.g., tone, speech speed), presence of background noise, and/or other factors, the invocation features generated from the spoken utterance may not exactly match the stored features that are accessible by the application that receives the encrypted audio data. In those instances, one or more algorithms that can decrypt using fuzzy matching (e.g., a vector that is within a threshold distance to the stored vector) can be utilized by the application to decrypt the spoken utterance. For example, in some instances, an utterance feature vector, generated from at least a portion of the audio data, may not be an exact match to a speaker feature vector that was previously generated for a user, even though both vectors may include the same speaker uttering the same phrase. However, utilizing one or more fuzzy matching techniques, the stored speaker feature vector may be utilized to decrypt the audio data, even if the audio data was encrypted using a non-matching vector.

In some implementations, an obfuscated version of a portion of the audio data can be generated prior to encrypting the audio data. For example, the audio data can first be processed to reduce background noise, omit at least a portion of the audio data (e.g., omit a portion that includes sensitive information), and/or otherwise processed to limit the audio data that is provided to an application prior to encrypting the audio data. Thus, upon decryption, the application may still not have access to all information that is included in the audio data, thereby further improving security of the user by limiting access to potentially sensitive information that may be included with the audio data.

Other implementations disclosed herein are directed to selectively providing the audio data to one or more applications based on determining that invocation features, provided by the application, match (either exactly or approximately, utilizing a fuzzy matching algorithm) features generated from the spoken utterance. For example, a DSP can process audio data that includes a spoken utterance of a user to generate features indicative of the spoken utterance. In response to identifying an invocation phrase included in the utterance, the DSP can provide a notification to one or more applications that audio data is available. One or more of the applications can provide invocation features (e.g., a previously stored vector) and the DSP can compare the provided vector with the vector generated based on the spoken utterance. In instances whereby the generated vector (or other features) matches the provided vector (or other features), the DSP can provide the audio data (or an obfuscated version of the audio data) to the application that provided the matching vector. Thus, the audio data is not encrypted but is instead provided only to the applications that provided a vector that matches the vector generated from the spoken utterance. By selectively providing the audio data only to those applications that can utilize the data, resource consumption required to transmit the audio data to an application is mitigated, resulting in improved performance of the computing device.

The above description is provided as an overview of only some implementations disclosed herein. Those implementations, and other implementations, are described in additional detail herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2A depicts an example of text dependent speaker verification according to one or more implementations disclosed herein.

FIG. 2B depicts another example of text dependent speaker verification according to one or more implementations disclosed herein.

FIG. 3A illustrates a flowchart of a method for providing encrypted audio data to one or more applications according to one or more implementations disclosed herein.

FIG. 3B illustrates a flowchart of a method of decrypting audio data utilizing utterance features of a user.

FIG. 4A illustrates a method of providing audio data to one or more applications in response to receiving speaker features from the one or more applications.

FIG. 4B illustrates a method of receiving audio data in response to providing speaker features for a user.

FIG. 5 illustrates an example architecture that can be utilized to implement one or more methods described herein.

### DETAILED DESCRIPTION

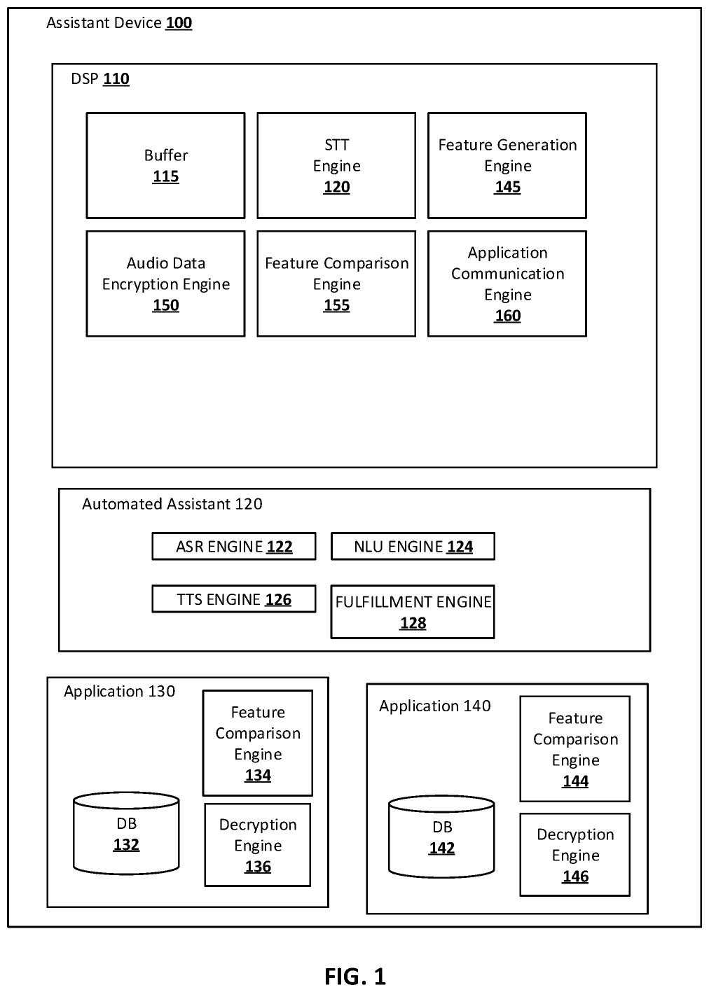

Turning initially to FIG. 1, an example environment is illustrated in which various implementations can be performed. FIG. 1 includes an assistant device 100 (i.e., a client device executing an automated assistant client and/or via which an automated assistant is otherwise accessible), which executes an instance of an automated assistant client 120. One or more cloud-based automated assistant components can be implemented on one or more computing systems (collectively referred to as a “cloud” computing system) that are communicatively coupled to assistant device 100 via one or more local and/or wide area networks (e.g., the Internet). An instance of an automated assistant client 120, optionally via interaction(s) with one or more of the cloud-based automated assistant components, can form what appears to be, from the user's perspective, a logical instance of an automated assistant with which the user may engage in a human-to-computer dialog.

The assistant device 100 can be, for example: a desktop computing device, a laptop computing device, a tablet computing device, a mobile phone computing device, a computing device of a vehicle (e.g., an in-vehicle communications system, an in-vehicle entertainment system, an in-vehicle navigation system), a standalone interactive speaker, a smart appliance such as a smart television, and/or a wearable apparatus that includes a computing device (e.g., a watch having a computing device, glasses having a computing device, a virtual or augmented reality computing device).

Assistant device 100 can be utilized by one or more users within a household, a business, or other environment. Further, one or more users may be registered with the assistant device 100 and have a corresponding user account accessible via the assistant device 100. Text-dependent (TD) speaker features(s) described herein can be generated and stored for each of the registered users (e.g., in association with their corresponding user profiles), with permission from the associated user(s). For example, a TD speaker features vector can be generated that is constrained to the term “OK Assistant,” which can be stored in association with a first registered user and have corresponding speaker features that are specific to the first registered user—and TD speaker features constrained to the term “OK Assistant” can be stored in association with a second registered user and have corresponding speaker features that are specific to the second registered user. TD techniques described herein can be utilized to authenticate an utterance as being from a particular user (instead of from another registered user or a guest user). Optionally, TI techniques, speaker verification, facial verification, and/or other verification technique(s) (e.g., PIN entry) can additionally or alternatively be utilized in authenticating a particular user. Further, speaker features generated via TD and/or TI techniques can be utilized to perform encrypting and/or decrypting of audio data, as further described herein.

Additional and/or alternative assistant devices may be provided and, in some of those implementations, speaker features for particular for a user can be shared amongst assistant devices for which the user is a registered user. In various implementations, the assistant device 100 may optionally operate one or more other applications (e.g., application 130 and 140) that are in addition to automated assistant 120, such as a message exchange client (e.g., SMS, MMS, online chat), a browser, and so forth. In some of those various implementations, one or more of the other applications can optionally interface (e.g., via an application programming interface) with the automated assistant 100, or include their own instance of an automated assistant application (that may also interface with any cloud-based automated assistant component(s)).

Automated assistant 120 engages in human-to-computer dialog sessions with a user via user interface input and output devices of the assistant device 100. To preserve user privacy and/or to conserve resources, in many situations a user must often explicitly invoke the automated assistant 120 before the automated assistant will fully process a spoken utterance. The explicit invocation of the automated assistant 100 can occur in response to certain user interface input received at the assistant device 100. For example, user interface inputs that can invoke the automated assistant 100 via the assistant device 100 can optionally include actuations of a hardware and/or virtual button of the assistant device 100. Moreover, the automated assistant client can include one or more local engines, such as an invocation engine that is operable to detect the presence of one or more spoken general invocation wakewords. The invocation engine can invoke the automated assistant 120 in response to detection of one of the spoken invocation wakewords. For example, the invocation engine can invoke the automated assistant 100 in response to detecting a spoken invocation wakeword such as “Hey Assistant,” “OK Assistant”, and/or “Assistant”. The invocation engine can continuously process (e.g., if not in an “inactive” mode) a stream of audio data frames that are based on output from one or more microphones of the assistant device 100, to monitor for an occurrence of a spoken invocation phrase. While monitoring for the occurrence of the spoken invocation phrase, the invocation engine discards (e.g., after temporary storage in a buffer) any audio data frames that do not include the spoken invocation phrase. However, when the invocation engine detects an occurrence of a spoken invocation phrase in processed audio data frames, the invocation engine can invoke the automated assistant 120. As used herein, “invoking” the automated assistant 120 can include causing one or more previously inactive functions of the automated assistant 120 to be activated. For example, invoking the automated assistant 120 can include causing one or more local engines and/or cloud-based automated assistant components to further process audio data frames based on which the invocation phrase was detected, and/or one or more following audio data frames (whereas prior to invoking no further processing of audio data frames was occurring). For instance, local and/or cloud-based components can process captured audio data using an ASR model in response to invocation of the automated assistant 120.

In some implementations, multiple automated assistants can be executing on the assistant device 100, and the uttered invocation phrase may be different for each automated assistant. For example, a first automated assistant can have an invocation phrase of “OK Assistant 1,” and in instances whereby the user utters the phrase “OK Assistant 1,” the first automated assistant can be invoked such that additional audio data that precedes and/or follows the invocation phrase can be processed by the first automated assistant. Similarly, a second automated assistant, also executing on the assistant device 100, can be invoked when the user utters a second invocation phrase, such as “OK Assistant 2,” whereby additional audio data that precedes and/or follows the invocation phrase can be processed by the second automated assistant. As further described herein, audio data can be encrypted using utterance features generated by the portion of the audio data that includes the user uttering the invocation phrase. Continuing with the previous example, in some implementations, the audio data that includes the user uttering “OK Assistant 1” can be encrypted with utterance features generated from the portion of the audio data that includes the user uttering “OK Assistant 1” such that only the first automated assistant (e.g., the automated assistant that is invoked with “OK Assistant 1”), having access to the speaker features generated from the user uttering “Ok Assistant 1,” can decrypt the audio data.

The automated assistant client 120 in FIG. 1 is illustrated as including an automatic speech recognition (ASR) engine 122, a natural language understanding (NLU) engine 124, a text-to-speech (TTS) engine 126, and a fulfillment engine 128. In some implementations, one or more of the illustrated engines can be omitted (e.g., instead implemented only by cloud-based automated assistant component(s) 140) and/or additional engines can be provided (e.g., an invocation engine described above).

The ASR engine 122 can process audio data that captures a spoken utterance to generate a recognition of the spoken utterance. For example, the ASR engine 122 can process the audio data utilizing one or more ASR machine learning models to generate a prediction of recognized text that corresponds to the utterance. In some of those implementations, the ASR engine 122 can generate, for each of one or more recognized terms, a corresponding confidence measure that indicates confidence that the predicted term corresponds to the spoken utterance.

The TTS engine 126 can convert text to synthesized speech, and can rely on one or more speech synthesis neural network models in doing so. The TTS engine 126 can be utilized, for example, to convert a textual response into audio data that includes a synthesized version of the text, and the synthesized version audibly rendered via hardware speaker(s) of the assistant device 100.

The NLU engine 124 determines semantic meaning(s) of audio and/or text converted from audio by the ASR engine, and determines assistant action(s) that correspond to those semantic meaning(s). In some implementations, the NLU engine 124 determines assistant action(s) as intent(s) and/or parameter(s) that are determined based on recognition(s) of the ASR engine 122. In some situations, the NLU engine 124 can resolve the intent(s) and/or parameter(s) based on a single utterance of a user and, in other situations, prompts can be generated based on unresolved intent(s) and/or parameter(s), those prompts rendered to the user, and user response(s) to those prompt(s) utilized by the NLU engine 124 in resolving intent(s) and/or parameter(s). In those situations, the NLU engine 124 can optionally work in concert with a dialog manager engine (not illustrated) that determines unresolved intent(s) and/or parameter(s) and/or generates corresponding prompt(s). The NLU engine 124 can utilize one or more NLU machine learning models in determining intent(s) and/or parameter(s).

The fulfillment engine 128 can cause performance of assistant action(s) that are determined by the NLU engine 124. For example, if the NLU engine 124 determines an assistant action of “turning on the kitchen lights”, the fulfillment engine 128 can cause transmission of corresponding data (directly to the lights or to a remote server associated with a manufacturer of the lights) to cause the “kitchen lights” to be “turned on”. As another example, if the NLU engine 124 determines an assistant action of “provide a summary of the user's meetings for today”, the fulfillment engine 128 can access the user's calendar, summarize the user's meetings for the day, and cause the summary to be visually and/or audibly rendered at the assistant device 100.

Assistant device 100 further includes a digital signal processor (DSP) 110 that can process incoming audio data and perform initial processing of the audio data. For example, although DSP 110 and automated assistant 120 are illustrated as separate components, at least a portion of the components of the automated assistant 120 can be executed by the DSP 110, such as initial ASR, STT processing, NLU, and/or other processing of incoming audio data. The DSP 110 includes a buffer 115 that can store a portion of audio data that is captured by, for example, one or more microphones of assistant device 100. In some implementations, the DSP 110 can be limited in computing power and/or capabilities such that audio data is at least partially processed only by the DSP 110 before audio data is provided to the automated assistant 120. Thus, for security purposes, audio data that is received can be temporarily stored in the buffer 115, processed by an invocation engine to determine whether the captured audio data requires further processing (e.g., whether the audio data includes a request by the user that requires fulfillment of the request), and/or provided to one or more applications 130 and 140 that are executing on the assistant device 100.

DSP 110 further includes a speech to text (STT) engine 120 that can generate text based on incoming audio data that is stored in buffer 115. For example, audio data can be captured by a microphone of assistant device 100 that includes a user uttering one or more requests, the audio data can be stored in buffer 115, and STT engine 120 can process the stored audio data to generate a textual representation of the utterance(s) of the user. The buffer 115 may be limited in its capacity to store audio data such that, at a given time, STT engine 120 may only have access to a limited amount of audio data (e.g., 10 seconds of audio data, a limited file size of audio data).

Further, DSP 110 can include one or more components that can analyze incoming audio data (and/or text representing incoming audio data) and determine whether the audio data includes a user uttering one or more phrases, such as an invocation phrase. In instances where the DSP 110 determines that audio data includes an invocation phrase, the DSP 110 can provide the audio data to the automated assistant 120 for further processing. Thus, DSP 110 can determine that the audio data includes a request for the automated assistant to perform one or more actions before the audio data has been forwarded to the automated assistant 120 and/or to other components (e.g., application 130 and application 140). Similarly, audio data can be processed to determine which application 130 and 140 is authorized to access the audio data before the audio data is provided to the application 130 and/or 140.

DSP 110 further includes a feature generation engine 145 that can generate one or more utterance features of audio data that is stored in buffer 115. The speaker generation engine 145 can generate speaker features for a user, using instances of audio data that each capture a corresponding spoken utterance of the user during normal non-enrollment interactions with an automated assistant via one or more respective assistant devices. For example, the speaker generation engine 145 can utilize a portion of an instance of audio data that captures a spoken utterance, in generating utterance features for a user, in response to determining that recognized term(s) (determined using speech recognition performed on the audio data) for the spoken utterance captured by that the portion correspond to the particular text associated with the TD technique being utilized.

In TD techniques, the one or more previously generated speaker embeddings of the user are generated based on spoken utterances that include only one or more particular words or phrases. Moreover, in use, the user must speak the one or more particular words or phrases for one or more TD speaker embedding to be generated using the TD model, which can be effectively compared to one or more previously generated TD speaker embeddings for the user to determine whether the spoken utterance is from a particular user (e.g., the user of the assistant device 100 or another user associated with the assistant device 100). For example, the one or more particular words or phrases in TD speaker recognition can be constrained to one or more invocation phrases configured to invoke the automated assistant (e.g., hot words and/or trigger words such as, for example, “Hey Assistant”, “OK Assistant”, and/or “Assistant”) or one or more warm words described herein. In contrast, for TI techniques, the spoken utterance processed using the TI model is not constrained to the one or more particular words or phrases. In other words, audio data based on virtually any spoken utterance can be processed using the TI model to generate a TI speaker embedding, which can be effectively compared (e.g., by feature comparison engine 155) to one or more previously generated TI speaker embeddings for the user to determine whether the spoken utterance is from the same user (e.g., the user of the assistant device 100 or another user associated with the assistant device 100). Moreover, in various implementations, the one or more previously generated TI speaker embeddings of the user utilized in TI techniques are generated based on spoken utterances that include disparate words and/or phrases and are not limited to invocation words and/or phrases, warm words, and/or any other particular spoken utterances.

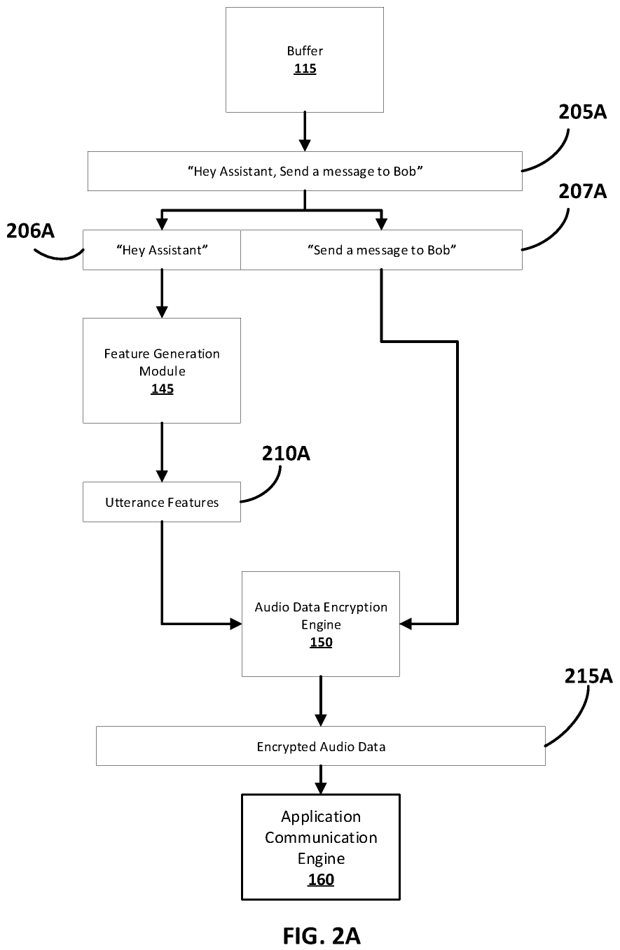

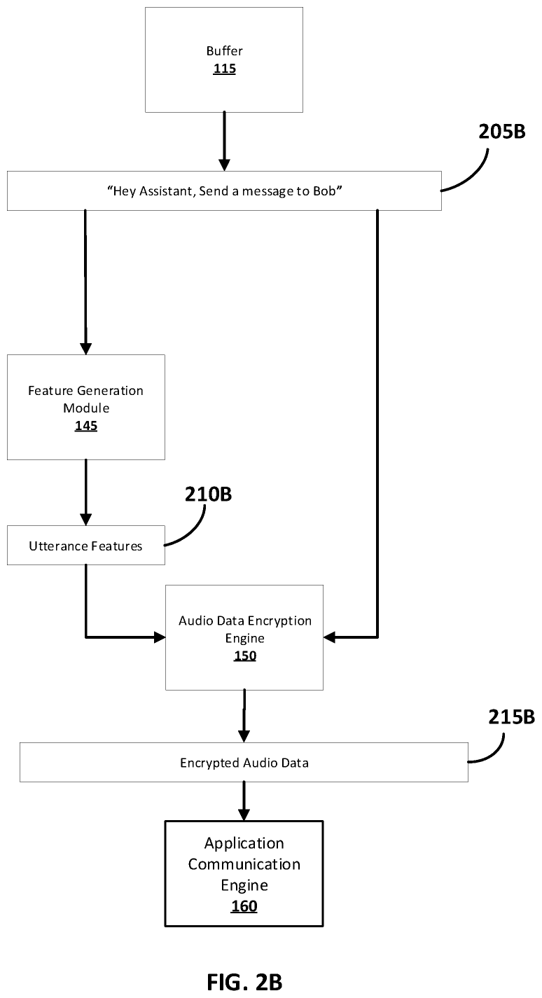

As an example, referring to FIG. 2A, a flowchart is provided that illustrates utilizing TD models to generate utterance features. The utterance 205A is provided by buffer 115, which can store audio data that is captured by one or more microphones of the client device. The utterance 205A includes a first portion 206A, “OK Assistant,” that can be an invocation phrase that indicates the user has interest in interacting with an automated assistant. Further, the utterance 205A includes a second portion 207A that indicates what action the user has interest in being performed by an automated assistant and/or by one or more other applications. As illustrated, feature generation module 145 can generate utterance features 210A from the first portion 206A to generate, for example, a vector that represents the utterance features. Thus, in this example, the utterance features are generated, using TD techniques, based on the portion of the audio data that includes the user uttering the invocation phrase. As described further herein, the utterance features 210A can be utilized to encrypt all or part of the audio data that includes the spoken utterance.

As an example of TI utterance feature generation, referring to FIG. 2B, a flowchart is provided that illustrates utilizing TI model(s) to generate utterance features. The utterance 205B is provided to the feature generation module 145, which then generates utterance features 210B based on the audio data. As opposed to the method illustrated in FIG. 2A, the utterance features 210B are not constrained to a particular phrase but instead are independent of what was uttered by the user. As further described herein, the TI utterance features can be utilized to encrypt audio data, such as the entirety of the spoken utterance 105B and/or a part of the audio data.

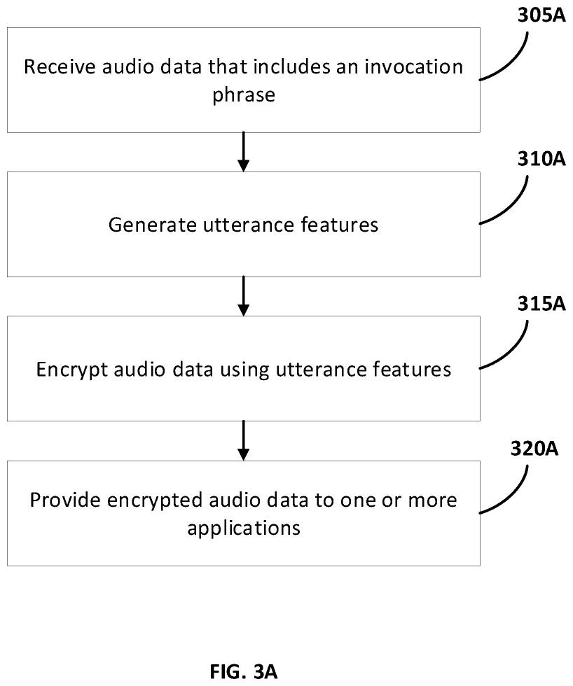

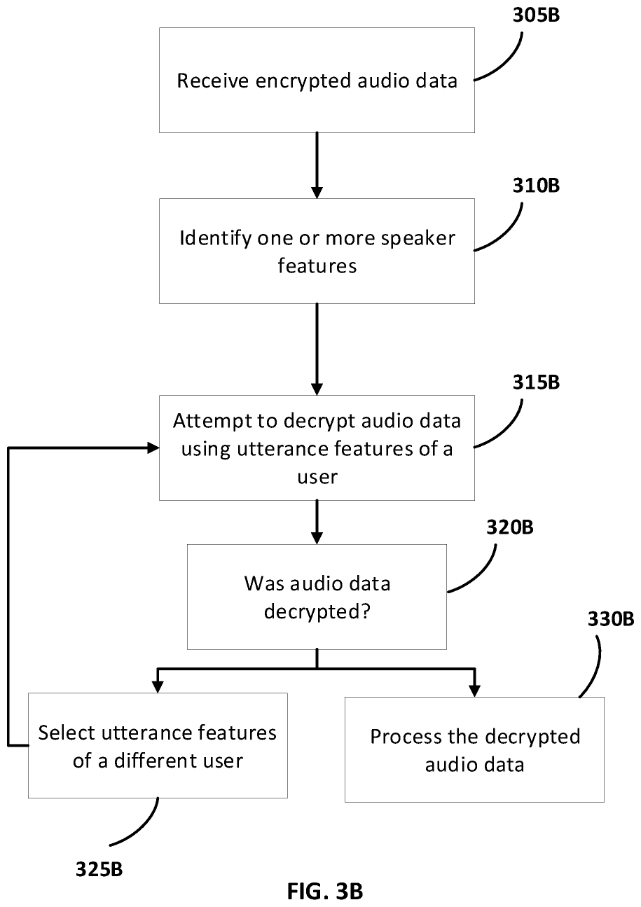

Referring to FIG. 3A, a flowchart is provided that illustrates one or more methods described herein. The steps of the illustrated method can be performed by one or more components of the system illustrated in FIG. 1. In some implementations, one or more of the steps of method 300 may be omitted and/or one or more additional steps can be included in the method 300.

At step 305A, audio data that includes an invocation phrase is received. In some implementations, the audio data can be received by a component that shares one or more characteristics with DSP 110. For example, audio data can be captured by a microphone of assistant device 100 and stored in buffer 115. In some implementations, the audio data can be initially processed by DSP 110 to determine whether the audio data includes the invocation phrase. In instances where an invocation phrase has been detected (e.g., through processing of a textual representation of the audio data, generated by STT engine 120, to determine whether the user uttered the invocation phrase, such as “Hey Assistant”), DSP 110 can provide the audio data and/or a textual representation of the audio data to one or more other components, such as automated assistant 120, application 130, and/or application 140.

At step 310A, speaker features are generated from the audio data. In some implementations, the speaker features can be generated by a component that shares one or more characteristics with feature generation engine 145. For example, in some implementations, feature generation engine 145 can generate TD features that are generated based on one or more particular terms and/or phrases (e.g., generated based on the portion of the audio data that includes the user uttering an invocation phrase). In some implementations, feature generation engine 145 can generate TI features based on other portions of the audio data that do not include a particular phrase and/or term (e.g., “turn on the kitchen lights”), and/or include additional phrases and/or terms in addition to the invocation phrase. In both instances, speaker features can include one or more vectors that are generated based on the model that is utilized to analyze the audio data.

Referring again to FIG. 1, DSP 110 further includes an audio data encryption engine 155. In some implementations, the audio data encryption engine 155 can encrypt audio data utilizing one or more features as a key to the encryption. For example, utterance features (and/or vectors representing utterance features) that are generated by feature generation engine 145 can be utilized as a key to the encryption of audio data that is stored in buffer 115. In some implementations, because the DSP 110 is a separate component that is not accessible by other components of the assistant device 115, DSP 110 can prevent other components from accessing the received audio data by only allowing encrypted audio data to be provided to other components, such as automated assistant 120, application 130, and/or application 140.

Referring again to FIG. 3A, at step 315A, audio data is encrypted utilizing the speaker features generated at step 310. In some implementations, the speaker features can be generated based on the user uttering a particular phrase (e.g., using TD-generated speaker features generated from audio of the user uttering “Hey assistant”) and/or from TI-generated speaker features. By utilizing speaker features as a key to encryption, other components that have access to previously generated speaker features (e.g., speaker features of a user that were generated during an enrollment period) can decrypt the audio data.

Referring again to FIG. 2A, the generated utterance features 210A are provided to the audio data encryption engine 150 along with a part of the audio data 207A. In some implementations, the entirety of the audio data 205A can be provided to the audio data encryption engine 150 for encrypting. In some implementations, only a part of the audio data (e.g., a single channel of multi-channel audio data, an obfuscated version of the audio data, the part of the audio data that does not include the invocation phrase) may be encrypted utilizing the utterance features 210A. The resulting encrypted audio data 215A can be provided to the application communication engine 160 for transmission to one or more applications, as described further herein. For example, one or more applications can attempt to decrypt the audio data utilizing one or more stored speaker features that are generated using a TD technique.

Referring again to FIG. 2B, the generated utterance features 210B are provided to the audio data encryption engine 150 along with the audio data 205B. In this instance, the entirety of the audio data is provided for encryption. However, as is the case with the audio data in FIG. 2A, only a part of the audio data may be provided for encrypting. The resulting encrypted audio data 215 is provided to application communication engine 160 for transmission to one or more applications for further processing, as described herein. For example, one or more applications can attempt to decrypt the audio data utilizing one or more stored speaker features that are generated using a TI technique.

Referring again to FIG. 1, DSP 110 further includes an application communication engine 160. The application communication engine 160 can communicate with one or more applications, such as application 130, application 140, and/or automated assistant 120, to indicate to the receiving application that audio data is available. For example, audio data can be stored in buffer 115 and STT engine 120 can generate a textual representation of the audio data. In some implementations, DSP 110 can further determine, based on one or more terms in the textual representation, one or more applications, including the automated assistant 120, that may be capable of utilizing the audio data. For example, the audio data may include the user uttering “OK Assistant, book me a flight using Application 1,” and DSP 110 can determine that the user is referring to application 130. In that instance, application communication engine 160 can communicate directly with application 130 and provide an indication that audio data is available and further that application 130 may be capable of fulfilling a request that is included in the audio data. In some implementations, an indication may first be provided to automated assistant 120, which may determine, based on one or more signals from the DSP 110, that an application may be capable of performing one or more tasks characterized by the utterance of the user that is captured in the audio data. For example, DSP 110 may generate a signal that is provided to automated assistant 120, via application communication engine 160, indicating the user has uttered the term “Application 1” and determine, based on the limited information provided to the automated assistant 120, that the audio data may be directed to application 130.

In some implementations, the automated assistant 120 can be provided the encrypted audio data by the DSP 110. In that instance, the automated assistant 120 may be capable of decrypting the audio data and/or may further facilitate transfer of the audio data to one or more applications. For example, DSP 110 can generate encrypted audio data that is encrypted based on utterance features generated from the portion of the audio data that includes the user uttering the phrase “OK Assistant” (e.g., the invocation phrase for automated assistant 120). Automated assistant 120 can then provide the encrypted audio data to application 130 and/or application 140 for further processing. Thus, in some implementations, DSP 110 may only transmit to an automated assistant, which may then determine which application(s) should be provided the encrypted audio data.

Based on the indication provided by the DSP 110 via the application communication engine 160, one or more applications that receive the indication may determine that the audio data is directed to the application. For example, in some implementations, DSP 110 may provide all and/or a plurality of applications with an indication that audio data is available. Further, DSP 110 may further provide some indication of the application that the user has indicated should process the spoken utterance included in the audio data. For example, the user may utter a name of a particular application (e.g., “book a flight using Application 1” includes an application name “Application”). Also, for example, the user may utter one or more keywords that indicate the type of request that is being made and DSP 110 may provide an indication of the keyword with an indication that audio data is available (e.g., provide “flight” with an indication that the user has uttered “Book me a flight”). In some implementations, as previously mentioned, automated assistant 120 may be utilized as an intermediary between the DSP 110 and the applications that can receive the encrypted audio data.

At step 320A, the encrypted audio data is provided to one or more applications. In some implementations, the encrypted audio data can be provided to multiple applications by the DSP 110. In some implementations, the encrypted audio data can be provided selectively to one or more applications based on preliminary processing by the DSP 110. For example, DSP 110 (or automated assistant 120) may determine, based on one or more terms that are included in the audio data, that one or more applications are the target application for the spoken utterance. In response, DSP 110 can provide indications of the presence of new audio data to only those applications that may likely be the target of the utterance of the user.

Referring again to FIG. 1 and as previously mentioned, assistant device 100 further includes application 130 and application 140. In some implementations, assistant device 100 can be executed via one or more processors of the assistant device 100. In some implementations, assistant device 100 may have more or fewer applications executing than are depicted in FIG. 1. For example, assistant device 100 may have an email application, a ride sharing application, and/or a calendar application that are all executing on the assistant device 100. Applications may be executing in the foreground or may be executing in the background. Thus, in some instances, an application may be actively accessed and/or utilized by a user of assistant device 100, or may be executing in a standby mode such that the application can receive and/or send information without the user actively accessing the application.

In some implementations, DSP 110 may be in communication with one or more of application 130 and application 140. For example, application communication engine 160 may provide encrypted audio data to application 130, and independently provide the same encrypted audio data to application 140. Each may include one or more components that can process received audio data and further may include corresponding fulfillment engines that are capable of performing one or more tasks in response to receiving audio data that includes a user uttering a request for performance of a task. In some implementations, one or more of application 130 and/or application 140 may be in further communication with automated assistant 120 such that, for example, DSP 110 may send at least a portion of an indication to automated assistant 120 for initial processing, and then automated assistant 120 can forward the indication (or a different indication) to an application. For example, automated assistant 120 may receive audio data from DSP 110, process the audio data utilizing TTS engine 126 to generate a textual representation of a spoken utterance, encrypt the audio data, and provide application 130 with the encrypted audio data. Also, for example, DSP 110 may first generate a textual representation of the utterance, encrypt the textual representations, and provide the encrypted textual representation (and/or other intermediate representations of the audio data, such as a spectrogram) in lieu of DSP 110 directly providing the encrypted audio data to application 130.

In some implementations, audio data (or a textual representation of the audio data) can be obfuscated prior to encrypting. For example, STT engine 120 may first generate a textual representation of the audio data and one or more components can determine whether the utterance includes one or more terms that are not necessary to provide to an application, omit those terms, and encrypt the remaining portions of the textual representation. Also, for example, portions of the audio data can be omitted (or otherwise obfuscated) before encrypting to remove or obscure at least a portion of the audio data that is not required by the target application.

As an example of the method illustrated in FIG. 3A, a user may utter the phrase, “OK Assistant, send a message using Application 1.” The audio data of the user uttering the phrase can be stored in buffer 115 for further processing. Feature generation engine 145 can then generate speaker features based on the portion of the user uttering “OK Assistant.” Alternatively or additionally, STT engine 120 can generate a textual representation of the audio data. Based on the speaker features generated by feature generation engine 145, the audio data, a textual representation of the audio data, and/or an obfuscated version of the audio data and/or of the textual representation can be encrypted by audio data encryption engine 150. The encrypted audio data and/or encrypted textual representation can then be provided to one or more other components, such as automated assistant 120, application 130, and/or application 140. In this manner, the unencrypted audio data is only available to the DSP 110 and is not available to other components. In some implementations, only a portion of the audio data can be encrypted and other portions of the audio data can be transmitted without encryption. For example, in some instances, a portion of the audio data can include sensitive information and only that portion of the audio data may be encrypted before providing the audio data or an intermediate representation of the audio data to one or more other components for further processing. Thus, in order for another application to access the portion with the sensitive information, speaker features may be required that allow the application to decrypt those portions of the audio data.

Referring to FIG. 3B, a flowchart is provided that illustrates one or more methods that may be executed by one or more applications executing on assistant device 100, such as application 130 and application 140. In some implementations, one or more steps of the illustrated method may be omitted and/or one or more additional steps may be performed. In some implementations, one or more steps of the illustrated method may be performed by one or more other components, such as automated assistant 120.

At step 305B, an application (e.g., application 130 and/or application 140) receives encrypted audio data and/or an encrypted textual representation of the audio data, either in its entirety or obfuscated as described herein. As previously described, the audio data has been encrypted utilizing speaker features that were determined by the DSP 110 (e.g., by feature generation engine 145 and encrypted by audio data encryption engine 150). For example, feature generation engine 145 may generate a vector that is indicative of the voice characteristics of the user that uttered “OK Assistant,” and generate a TD vector that is unique for that utterance. The generated vector can be utilized by the audio data encryption engine 150 as a key to encrypt the audio data before providing the encrypted audio data to one or more applications 130 and/or 140.

Application 130 includes (or has access to) a database 132 that includes one or more utterance features (e.g., vectors representing speaker features). The speaker features can, in some instances, be based on previous interactions with users. For example, a user may be requested to utter a phrase (e.g., “OK Assistant”) a number of times during an enrollment period, and a vector can be generated that is an average of the utterances such that the resulting vector is an approximation of the user's prosodic features while uttering a particular phrase. Thus, in some instances, the database 132 may include text-dependent utterance features that represent the user uttering a particular phrase. In some instances, a vector may be generated that is independent from the user uttering a particular phrase and thus the resulting vector can be text-independent. This type of vector may be generated based on the user uttering various phrases, which then can be averaged such that the resulting vector is representative of general prosodic features that are unique to the user that uttered the phrase(s). As described herein, “utterance features” and/or “features vector” can include either TD or TI utterance features of users such that, for a given user, a unique vector (either TD or TI) can be generated that can be utilized to encrypt and/or decrypt audio data.

Application 140 further includes (or has access to) database 142 that includes one or more features vectors for users. As with database 132, the feature vectors can be TD or TI, and are each unique to a user. In some implementations, database 132 and database 142 may be the same database, with application 130 having access to one or more vectors, and application 140 having access to one or more vectors. Thus, a database may be maintained that includes multiple vectors for multiple users, with access to each vector selectively granted to particular applications. For example, automated assistant 120 may maintain a database and selectively grant access to speaker feature vectors based on permissions granted by the user.

In some implementations, application communication engine 160 may provide the encrypted audio data to the applications 130 and/or 140 with one or more indications of the user that uttered the phrase. For example, first encrypted audio data may be provided with an indication of “User 1,” and second encrypted audio data may be provided with an indication of “User 2.” In some implementations, one or more applications 130 and 140 may have access to a feature vector for “User 1” via the respective databases. Additionally or alternatively, one or more of application 130 and 140 may have access, via respective databases, to a feature vector for “User 2” and/or for both “User 1” and “User 2.”

As an example, User 1 may utter a phrase that is captured in audio data, with the phrase including the terms “OK Assistant.” DSP 110 may generate a feature vector based on User 1 uttering “OK Assistant” and encrypt the audio data with the feature vector. In some implementations, DSP 110 may also determine an indication of the identity of the speaker of the utterance (i.e., User 1) and provide the audio data to both application 130 and application 140. To continue with the example, application 130 may have access to a feature vector for User 1 that is generated based on the user previously uttering “OK Assistant” such that the vector to which application 130 has access is the same (or similar) to the vector that was utilized by DSP 110 to encrypt the audio data. In some implementations, DSP 110 may provide audio data to both application 130 and 140 with an indication of the user that uttered the phrase captured in the audio data. Thus, application 130 can check, in database 132, to determine if application 130 has access to a features vector for User 1. Similarly, application 140 can check in database 142 to determine whether application 140 has access to a features vector for User 1. In some instances, only application 130 may have access to the features vector for User 1, whereas application 140 has not been granted access to the same features vector.

At step 310B, the receiving application (e.g., application 130 and/or 140) identifies one or more speaker features that are stored in a database accessible to the application (e.g., database 132 or database 142, depending on the receiving application). In some implementations, an application may identify a plurality of potential speaker features, each associated with a unique user. In instances where DSP 110 has provided an indication of the user that uttered the phrase captured in the audio data, the application can determine whether it has access to utterance features for that user.

In some implementations, encrypted audio data can be provided with an indication of a type of application that can process the audio data. In those instances, an application may first determine whether it can process the audio data before checking for speaker features. For example, encrypted audio data can be provided to application 130, which can be a messaging application, and application 140, which can be a flight booking application. The encrypted audio data can be provided to both applications with an indication that the audio data is related to booking a flight (e.g., “Book a flight to Miami” or “Book a flight to Miami using Application 2”), such as an indication that the audio data is a “book flight” request. In that instance, for example, application 130 may not perform any additional processing and/or may not identify potential speaker features based on determining that it will not be able to process the audio data, even if it is decrypted. Conversely, application 140, which is configured to handle the request for booking a flight, may identify one or more speaker features based on determining that it is likely the request can be handled by the application 140.

Referring again to FIG. 1, Application 130 includes a decryption engine 136 that can decrypt audio data using speaker features. For example, application 130 can receive encrypted audio data that is encrypted using utterance features derived from the audio data. The encrypted audio data can then be provided to application 130. In response, decryption engine 136 may identify one or more speaker feature vectors in database 132 that were previously generated based on utterances from the user (e.g., based on a user, in an enrollment period, uttering the phrase “OK Assistant” multiple times). Using one or more techniques, decryption engine 136 can attempt to decrypt the audio data using the identified speaker features.

Referring again to FIG. 3B, at step 315B, the application attempts to decrypt the audio data using identified speaker features. For example, the application 130 can access first speaker features for a first user and attempt to decrypt the encrypted audio data utilizing one or more encryption/decryption techniques. In some implementations, one or more fuzzy algorithms can be utilized to perform the decryption. For example, the utterance features that were utilized by the DSP 110 to encrypt the audio data may not be identical to utterance features that are accessible to an application. However, using one or more fuzzy matching algorithms, the application may utilize similar utterance features to attempt to decrypt the encrypted audio data. Thus, an exact match between the encryption key (i.e., the utterance features utilized by the DSP 110 to encrypt the audio data) and the decryption key (i.e., the speaker features utilized by an application to attempt to decrypt the audio data) is not required for the application to decrypt the audio data.

As a working example, database 132 can include a speaker feature vector for each of User 1, User 2, and User 3. Similarly, database 142 can include a speaker feature vector for each of User 4 and User 5. User 3 may utter “OK Assistant, send a message to Bob,” which is then encrypted using utterance features derived from the audio data. At step 305B, the encrypted audio data is received by both application 130 and application 140. At step 310B, each of the applications identifies speaker features for a user in the respective databases (e.g., database 132 for application 130 and database 142 for application 140). For example, at step 310B, application 130 can identify speaker features for User 1, and application 140 can identify speaker features for User 4. At step 315B, application 130 can attempt to decrypt the encrypted audio data using the speaker features of User 1 and application 140 can attempt to decrypt the audio data using the speaker features of User 4.

At decision block 320B, application 130 and/or application 140 can determine whether the speaker features utilized to attempt to decrypt the encrypted audio data successfully decrypted the audio data. If not, at step 325B, different speaker features can be identified by the application(s) and utilized at step 315B to attempt to decrypt the encrypted audio data. If the audio data was successfully decrypted, at step 330B, the audio data can be processed by the application. For example, continuing with the previous example, because the utterance was from User 3, neither application 130 nor application 140 would successfully utilize the speaker features of User 1 and User 4, respectively, to decrypt the audio data. At step 325B, application 130 can identify another speaker features vector (e.g., the speaker features of User 2) and application 130 can identify another speaker features vector (e.g., the speaker features of User 5). Because neither User 2 nor User 5 were the speakers of the utterance, neither application would be successful in decrypting the audio data. At step 325B, application 140 does not have any other speaker features vectors to utilize to attempt to decrypt the audio data and therefore is unable to process the audio data to perform one or more tasks that are requested by the user. Application 130 identifies the speaker features vector for User 3 and, at step 315B, attempts to utilize the vector to decrypt the encrypted audio data. At step 320B, application 130 identifies that the audio data was successfully decrypted and, at step 330B, processes the audio data. The audio data, which includes audio of the user uttering “Send a message to Bob,” is processed and one or more tasks are performed (e.g., providing an interface to the user, automatically sending a message).

In some implementations, in lieu of encrypting audio data utilizing one or more utterance features that are generated from at least a portion of the audio data, DSP 110 may notify one or more applications that audio data is available prior to sending the audio data. In response, the one or more applications can provide speaker features that can be compared to utterance features generated from the audio data by feature generation engine 145 and, in the instance that the provided speaker features match the utterance features (either exactly or approximately, utilizing one or more fuzzy logic matching techniques), the audio data can be provided to the application that provided the matching speaker features. Referring to FIG. 1, feature comparison engine 155 can compare speaker features to one or more stored speaker features to generate a metric indicative of similarity between the speaker features and one or more of the stored speaker features. For example, feature generation engine 145 can generate speaker features for a user uttering a phrase, such as “Hey Assistant.” The speaker features can be stored in a database that includes speaker features for other users uttering the phrase “Hey Assistant.” Thus, for each user, a unique set of features is generated for each user that is indicative of the prosodic features of that user's voice. When an utterance is received by the DSP 110, feature generating engine 145 can generate speaker features for the utterance and provide the new speaker features to feature comparison engine 155. Feature comparison engine 155 can generate a metric, for each stored set of speaker features, that indicates a similarity between the particular stored speaker features and the newly received speaker features.

As an example, in an enrollment period, speaker features can be generated based on the user uttering an invocation phrase, such as “Hey assistant.” The features generated for each iteration of the user uttering the invocation phrase can be utilized (e.g., averaged) to generate a set of speaker features that can be compared with other speaker features and/or to other features generated from audio data (e.g., utterance features). For example, the speaker features can be stored in a database and when the user subsequently utters the invocation phrase, feature generate engine 145 can generate utterance features for that instance. Stored speaker features can be compared to the utterance features and utilized to determine whether a particular set of speaker features was generated from audio data of the same user as the user who spoke in the audio data currently stored in buffer 115. In the case that an application has access to the matching speaker features, that application can be determined to be authorized to receive the audio data and application communication engine 160 can provide the audio data, unencrypted, to the application.

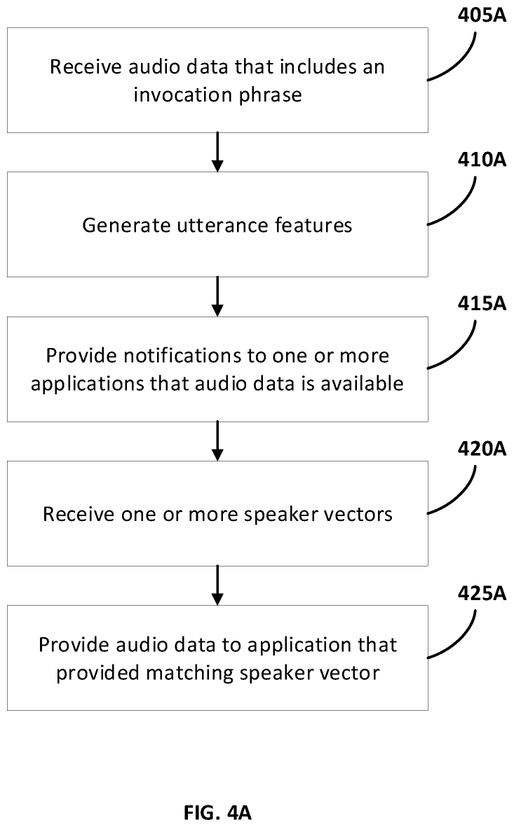

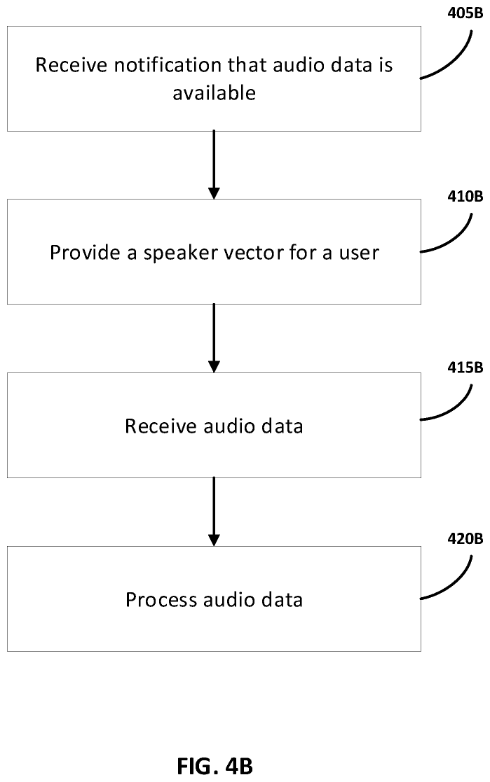

Referring to FIG. 4A, a flowchart is provided that illustrates an example method of providing audio data to an authorized application. At step 405A, audio data that includes an invocation phrase is received. The audio data may be temporarily stored in buffer 115 and can be only accessible to the DSP 110. Thus, until an application is determined to be authorized to receive the audio data, the audio data is not available to any other component. At step 410A, utterance features are generated from the audio data. In some implementations, step 410A can share one or more characteristics with step 310A of FIG. 3A. For example, the utterance features can be generated using TD techniques (e.g., generated on the portion of the audio data that includes the user uttering the invocation phrase) and/or can be generated using TI techniques (e.g., on a part or the entirety of the audio data, independent of the utterance). Thus, step 410A can be performed by a component that shares one or more characteristics with feature generation engine 145.

At step 415A, a notification is provided to one or more applications that audio data is available. For example, in some implementations, one or more components of DSP 110 can determine an intent of a request in audio data and determine which application(s) may be configured to fulfill the request. In some implementations, DSP 110 can identify a name of an application that is included in the utterance and provide a notification directly to that application. For example, for an utterance of “Hey Assistant, set a reminder to call the office on Tuesday,” STT engine 120 can generate a textual representation of the utterance and one or more components can determine that “set a reminder” is a task that can be fulfilled by a calendar application. Thus, in some implementations, application communication engine 160 can identify one or more applications (e.g., application 130 and/or application 140) and further provide, to one or both applications, that audio data related to “set a reminder” is available. In some implementations, application communication engine 160 may only send the notification to a calendar application. In some implementations, application communication engine 160 may send the request to all applications. Also, for example, for an utterance of “Hey Assistant, set a reminder using Application 1,” application communication engine 160 can send a notification only to Application without sending the notification to other applications that the user has not indicated.

At step 420A, one or more applications provide speaker features that were previously generated from audio data of one or more users uttering a phrase. For example, as previously described, a user may be requested to utter a phrase during an enrollment period and speaker features can be generated from the user utterance(s). In some implementations, the generated speaker features can be selectively provided to one or more applications based on permissions that are granted by the user. For example, the user may grant application 130 access to audio data and, in response, speaker features for the user can be provided to application 130, which may be stored in database 132. Similarly, the user may not grant application 140 access to audio data and therefore, by not providing application 140 with the speaker features for the user, application 140 does not have access to the same speaker features as application 130.

At step 420A, one or more speaker features are provided to the DSP 110. For example, in step 415A, application 130 may be provided with a notification that audio data is available. In response, application 130 may provide one or more sets of speaker features (e.g., a speaker feature vector) that is stored in database 132. At step 425A, the utterance features generated from the audio data and the speaker features received from an application are compared using one or more techniques (e.g., exact matching and/or a fuzzy matching technique). For example, DSP 110 can be provided with a speaker feature vector and feature comparison engine 155 can compare the provided speaker features with the utterance features generated by feature generation engine 145. If the features match (e.g., exactly, approximately), at step 430A, the audio data can be provided to the application that provided the speaker features.

Referring to FIG. 4B, a flowchart is provided that illustrates a method of receiving audio data in response to providing speaker features. In some implementations, the method of FIG. 4B can be performed by a component that shares one or more characteristics with application 130 and/or 140 of FIG. 1. In some implementations, one or more steps may be omitted, combined, and/or one or more additional steps may be included in the method.

At step 405B, a notification is received that audio data is available. The notification can be provided by a component that shares one or more characteristics with DSP 110, as described herein. For example, application communication engine 160 can provide a notification that includes an indication of the target application for a request (e.g., “application 1”) included in the audio data, an indication of the type of request (e.g., “messaging request”), and/or may only include an indication that audio data is available. In some implementations, a notification can further include an indication of a speaker of the utterance included in the audio data (e.g., “User 1”) and/or other information that can be utilized by an application to determine whether available audio data may include a request that can be fulfilled by the application.

At step 410B, speaker features are provided in response to the notification that audio data is available. In some implementations, the application (e.g., application 130 and/or 140) may both be provided with the notification and may each independently provide speaker features for one or more users. For example, application 130 may have access to speaker features for User 1 and User 2, stored in database 132. Also, for example, application 140 may have access to speaker features for User 3, stored in database 142. In some implementations, each application can provide one or more speaker features to the DSP 110 in response to receiving a notification from the DSP 110 that audio data is available.

At step 415B, audio data is received in response to providing the speaker features. As previously described, the audio data can be provided to applications that have provided, at step 410B, speaker features that match the utterance features generated from the audio data. For example, continuing with the previous example, if DSP 110 provided a notification that audio data was available, and the audio data includes an utterance that was uttered by User 2, only application 130, after providing the speaker features for User 2, would be provided with the audio data. At step 420B, the received audio data is processed. The audio data can be processed by a fulfillment engine of the receiving application, such as by fulfillment engines 134 and 144.

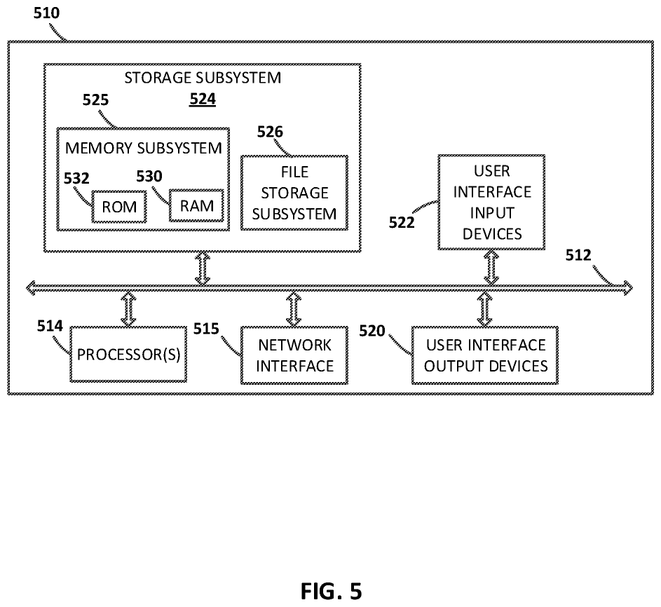

FIG. 5 is a block diagram of an example computing device 510 that may optionally be utilized to perform one or more aspects of techniques described herein. Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods of FIGS. 3A-4B, and/or to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In some implementations, a method implemented by one or more processors is provided herein and includes the steps of processing a stream of audio data, detected via one or more microphones of the client device, to monitor for a spoken invocation phrase. In response to detecting an occurrence of the spoken invocation phrase in a portion of the audio data, the method further includes the steps of processing at least the portion of the audio data to generate utterance features, encrypting, using the utterance features as an encryption key, at least part of the audio data to generate encrypted audio data, and outputting the encrypted audio data without outputting any unencrypted form of the at least part of the audio data.

These and other implementations of the technology disclosed herein can include one or more of the following features.

In some implementations, the at least part of the audio data includes preceding audio data that precedes the portion of the audio data and/or following audio data that follows the portion of the audio data. In some implementations, the at least part of the audio data includes the portion of the audio data detected to include the occurrence of the spoken invocation phrase. In some implementations, the one or more processors consist of a digital signal processor (DSP) of the client device and wherein outputting the encrypted audio data comprises outputting the encrypted audio data to an additional processor of the client device.

In some implementations, processing the invocation portion of the audio data to generate the utterance features includes processing the utterance features, using a text-dependent speaker verification machine learning model, to generate an utterance vector; and generating the utterance features based on the utterance vector. In some of those implementations, generating the utterance features based on the utterance vector comprises using the utterance vector as the utterance features.

In some implementations, outputting the encrypted audio data causes an application, executing on the client device, to attempt to decrypt the audio data using one or more pre-stored speaker features that are accessible to the application. In some of those implementations, the one or more pre-stored speaker features are generated during an enrollment procedure with the application or with an operating system of the client device. In other of those implementations, in attempting to decrypt the audio data using the one or more pre-stored speaker features, the application uses approximate speaker feature matching.

In some implementations, the method further includes, prior to encrypting the at least part of the audio data, generating an obfuscated version of the at least part of the audio data, wherein encrypting the audio data comprises encrypting the obfuscated version of the at least part of the audio data. In some of those implementations, generating the obfuscated version of the at least part of the audio data comprises omitting at least a segment of the at least part of the audio data to generate the obfuscated version of the at least part of the audio data. In other of those implementations, generating the obfuscated version of the portion of the audio data includes augmenting at least some of the portion of the audio data with noise to generate the obfuscated version of the portion of the audio data.

In some implementations, the at least part of the audio data includes preceding audio data that precedes the portion of the audio data, and wherein the preceding audio data is retrieved from a local buffer accessible to only the one or more processors.

In another aspect, a method implemented by one or more processors is provided and includes the steps of processing a stream of audio data, detected via one or more microphones of the client device, to monitor for a spoken invocation phrase, processing at least a portion of the audio data to generate utterance features, and receiving one or more speaker features provided by a target of a request included in audio data, determining whether the received speaker features match the utterance features. In response to determining that the speaker features match the utterance features, the method further includes outputting the audio data to the target of the request, and in response to determining that the speaker features do not match the utterance features, suppressing outputting of the audio data to the target of the request.

These and other implementations of the technology disclosed herein can include one or more of the following features.

In some implementations, the one or more processors includes a digital signal processor, and wherein the target is executing on a separate processor from the digital signal processor. In some of those implementations, the target of the request is an additional processor, an application, or an operating system. In some implementations, the method further includes identifying the target for the request based on the audio data, and providing one or more notifications that indicate the target of the request. In some of those implementations, the one or more notifications includes a type of the request.

In another aspect, a method implemented by one or more processors is provided and includes the steps of receiving encrypted audio data of a user speaking an utterance, wherein the encrypted audio data is encrypted using one or more utterance features of the user, decrypting the audio data, utilizing one or more vectors generated from prior occurrences of the user speaking one or more utterances, to generate decrypted audio data, processing the decrypted audio data; and causing performance of one or more computer actions based on the processing of the decrypted audio data.

These and other implementations of the technology disclosed herein can include one or more of the following features.

In some implementations, the one or more utterance features are generated based on the user uttering an invocation phrase included in the audio data. In some implementations, the one or more vectors are generated during an enrollment procedure. In some implementations, the audio data is received from a digital signal processor (DSP). In some of those implementations, the audio data is received by an application that is executing on one or more processors that are separate from the DSP.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include an automated assistant client device (e.g., a client device including at least an automated assistant interface for interfacing with cloud-based automated assistant component(s)) that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

In situations in which certain implementations discussed herein may collect or use personal information about users (e.g., user data extracted from other electronic communications, information about a user's social network, a user's location, a user's time, a user's biometric information, and a user's activities and demographic information, relationships between users, etc.), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so.

For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented by one or more processors of a client device, the method comprising:
processing a stream of audio data, detected via one or more microphones of the client device, to monitor for a spoken invocation phrase;
in response to detecting an occurrence of the spoken invocation phrase in a portion of the audio data:
processing at least the portion of the audio data to generate utterance features;
encrypting, using the utterance features as an encryption key, at least part of the audio data to generate encrypted audio data; and
outputting the encrypted audio data without outputting any unencrypted form of the at least part of the audio data.

2. The method of claim 1, wherein the at least part of the audio data includes preceding audio data that precedes the portion of the audio data and/or following audio data that follows the portion of the audio data.

3. The method of claim 1, wherein the at least part of the audio data includes the portion of the audio data detected to include the occurrence of the spoken invocation phrase.

4. The method of claim 1, wherein the one or more processors consist of a digital signal processor (DSP) of the client device and wherein outputting the encrypted audio data comprises outputting the encrypted audio data to an additional processor of the client device.

5. The method of claim 1, wherein processing the invocation portion of the audio data to generate the utterance features comprises:
processing the utterance features, using a text-dependent speaker verification machine learning model, to generate an utterance vector; and
generating the utterance features based on the utterance vector.

6. The method of claim 5, wherein generating the utterance features based on the utterance vector comprises using the utterance vector as the utterance features.

7. The method of claim 1, wherein outputting the encrypted audio data causes an application, executing on the client device, to attempt to decrypt the audio data using one or more pre-stored speaker features that are accessible to the application.

8. The method of claim 7, wherein the one or more pre-stored speaker features are generated during an enrollment procedure with the application or with an operating system of the client device.

9. The method of claim 7, wherein, in attempting to decrypt the audio data using the one or more pre-stored speaker features, the application uses approximate speaker feature matching.

10. The method of claim 1, further comprising:
prior to encrypting the at least part of the audio data:
generating an obfuscated version of the at least part of the audio data,
wherein encrypting the audio data comprises encrypting the obfuscated version of the at least part of the audio data.

11. The method of claim 10, where generating the obfuscated version of the at least part of the audio data comprises:
omitting at least a segment of the at least part of the audio data to generate the obfuscated version of the at least part of the audio data.

12. The method of claim 10, where generating the obfuscated version of the portion of the audio data comprises:
augmenting at least some of the portion of the audio data with noise to generate the obfuscated version of the portion of the audio data.

13. The method of claim 1, wherein the at least part of the audio data includes preceding audio data that precedes the portion of the audio data, and wherein the preceding audio data is retrieved from a local buffer accessible to only the one or more processors.

14. A method implemented by one or more processors of a client device, the method comprising:
processing a stream of audio data, detected via one or more microphones of the client device, to monitor for a spoken invocation phrase;
processing at least a portion of the audio data to generate utterance features;
receiving one or more speaker features provided by a target of a request included in audio data;
determining whether the received speaker features match the utterance features;
in response to determining that the speaker features match the utterance features:
outputting the audio data to the target of the request; and
in response to determining that the speaker features do not match the utterance features:
suppressing outputting of the audio data to the target of the request.

15. The method of claim 14, wherein the one or more processors includes a digital signal processor, and wherein the target is executing, at least partially, on a separate processor from the digital signal processor.

16. The method of claim 14, wherein the target of the request is an additional processor, an application, or an operating system.

17. The method of claim 14, further comprising:
identifying the target for the request based on the audio data; and
providing one or more notifications that indicate the target of the request.

18. The method of claim 17, wherein the one or more notifications includes a type of the request.

19. A method implemented by one or more processors of a client device, the method comprising:
receiving encrypted audio data of a user speaking an utterance, wherein the encrypted audio data is encrypted using one or more utterance features of the user;
decrypting the audio data, utilizing one or more vectors generated from prior occurrences of the user speaking one or more utterances, to generate decrypted audio data;
processing the decrypted audio data; and
causing performance of one or more computer actions based on the processing of the decrypted audio data.

20. The method of claim 19, wherein the one or more utterance features are generated based on the user uttering an invocation phrase included in the audio data.
